(19) United States
(12) Patent Application Publication
(10) Pub. No.: US 2014/0192694 A1
(43) Pub. Date: Jul. 10, 2014

(54) TRIGGERING DOWNLINK TRAFFIC WITH TIMING INDICATION

(71) Applicant: Broadcom Corporation, Irvine, CA (US)

(72) Inventor: Anna Pantelidou, Oulu (FI)

(73) Assignee: Broadcom Corporation, Irvine, CA (US)

(21) Appl. No.: 14/150,117

(22) Filed: Jan. 8, 2014

Related U.S. Application Data
(60) Provisional application No. 61/750,132, filed on Jan. 8, 2013.

(51) Int. Cl. H04W 52/02

(52) U.S. Cl. CPC H04W 52/0216
USPC 370/311

(57) ABSTRACT

A method, apparatus and computer program product are provided in order to provide a technique to trigger downlink traffic with a timing indication. The method, apparatus and computer program product may utilize one or more of a (1) “downlink transmission time” in the synch NDP frame indicating the beginning of downlink data transmission; (2) “downlink transmission restricted access” in the synch NDP frame starting at “downlink transmission time” during which downlink data transmission will take place to one or more STAs; (3) an indication in the NDP frame whether the downlink data transmission is unicast or broadcast; (4) ACK as a response to an NDP frame indicating whether the STA will be available to receive data at downlink transmission time or not; or (5) a new message format for the short NDP frame with timing information.

### CROSS REFERENCE TO RELATED APPLICATION

This application is a non-provisional of and claims the benefit of U.S. Provisional Application No. 61/750,132, filed on Jan. 8, 2013, the entire contents of which are hereby incorporated by reference.

### TECHNOLOGICAL FIELD

An example embodiment relates generally to communications within a network and, more particularly, to providing a null data packet frame with a timing indication for triggering downlink traffic.

### BACKGROUND

In IEEE 802.11-11/1137r12 proposed specification Framework for TGah, the access point (AP) must be able to support a potentially high number of associated stations (STAs). In some meter-to-pole applications the number of associated STAs may be 6000 or more. Furthermore, the devices at the STAs may be low rate devices that have to reach an AP which may be as far as 1 km away. For such use cases, energy efficiency of the battery-powered sensors is essential. To achieve energy efficiency the devices may attempt to stay in low power operation for long periods of time and may be configured to sleep as much as possible. Furthermore, the devices may be configured to avoid unnecessary transmissions, such as for signaling the AP and receptions e.g., to receive beacons.

One proposed solution comprises low duty cycle uplink and downlink traffic with strict delay constraints in receiving downlink data. For instance, there may be a strict latency requirement for an AP to respond to an alarm (e.g., fire or temperature drop) sent by a STA within 1 sec of time. Other types of applications may have different latency requirements. For instance, 100 msec of latency is expected as a response to commands such as in actuators. To meet these downlink delay constraints, a sensor must monitor its AP for data periodically (e.g., the STA should check the beacon periodically, with a period smaller than the maximum delay requirement). Alternatively, each STA should send a PS-Poll message, frequently enough so that the maximum delay constraint is met, to request downlink traffic.

However, sending PS-Polls to request downlink traffic can be problematic as it increases the contention from the STAs and can lead to collisions. For example in the case of gaming or actuators the STAs would need to monitor the AP (e.g., sending PS-Polls) for 100 msec in the worst case. Using beacons, (e.g., a short beacon or regular beacon), to indicate downlink data may not be efficient since the traffic indication maps (TIMs) have specific size limitations and the size may be large, making the frame longer and its decoding energy inefficient. This is especially inefficient for STAs that have very little traffic. For such cases it is better for the AP to indicate to the STAs when the downlink data is available through a short message.

As such, 11-12-1324-00-00ah-very-low-energy-paging provides for a paging protocol that has been accepted in the specification document of 802.11ah using a short null data packet (NDP) frame for paging. This short NDP frame includes the following fields: a partial identifier of the target STA(s)/group of STAs being paged; one bit indicating whether there is a buffer unit (BU) for the STA; synchronization info, e.g. a few least significant bits (LSBs) of timestamp; and one or more bits indicating if the STA need to check the beacon. When requested by a STA, the AP schedules a very short paging message at the target wake time of the STA as the next frame of transmission. If the STA receives the message, the STA (1) acts as if it received a TIM indicating BUs, e.g. send power save (PS)-Poll or trigger frame; (2) reads the next (short) beacon and proceeds as in regular PS; and (3) waits for a further poll message from AP after a certain time. However, if the NDP message indicates the presence of downlink traffic then in some cases it may be redundant for the STAs to listen to beacons again or send a PS Poll.

### BRIEF SUMMARY

A method, apparatus and computer program product are therefore provided in order to provide a technique to trigger downlink traffic with a timing indication. In this regard, the method, apparatus and computer program product of one embodiment may utilize one or more of a (1) “downlink transmission time” in the synch NDP frame indicating the beginning of downlink data transmission; (2) “downlink transmission restricted access” in the synch NDP frame starting at “downlink transmission time” during which downlink data transmission will take place to one or more STAs; (3) an indication in the NDP frame whether the downlink data transmission is unicast or broadcast; (4) ACK as a response to an NDP frame indicating whether the STA will be available to receive data at downlink transmission time or not; or (5) a new message format for the short NDP frame with timing information.

Indeed, the method, apparatus and computer program product of an example embodiment improves downlink transmission efficiency, improves energy efficiency since there is no need to listen to beacons, and improves downlink access synchronization.

In one embodiment of the present invention, a method is provided that comprises causing a transmission block to be provided with the transmission block comprising a first portion indicating at least one target station, a second portion indicating a presence of downlink traffic, and a third portion indicating a transmission time, receiving an acknowledgment signal from the at least one target station, and causing data to be provided to the at least one target station at the transmission time. Another embodiment may further include determining that the acknowledgement signal indicates that the at least one target station is unable to receive data at the transmission time and causing postponement of transmission of data to the at least one target station.

In another embodiment the transmission time is a time at which the transmission will start, and the transmission block further comprises a fourth portion indicating at least one of a transmission stop time or a transmission duration. The method may further include causing transmission access to be provided, wherein the transmission block further comprises a fifth portion indicating whether the provided data is transmitted unicast or multicast, and a sixth portion indicating identification of each of the at least one target station, and wherein transmission access is provided as a function of a number of target stations identified, the unicast or multicast indication and a transmission duration.

In another embodiment of the present invention, when a plurality of target stations are identified and transmission is unicast, the method may further comprise providing a number of transmission slots such that each target receives a transmission slot during the transmission duration and the transmission time indicates a transmission start time for each of the plurality of target stations respectively. In another embodiment, when a plurality of target stations are identified and transmission is multicast, the method may further comprise providing a single transmission slot such that each target receives the transmission at the transmission time.

In another embodiment of the present invention a method is provided including receiving a transmission block comprising a first portion indicating at least one target station, a second portion indicating a presence of downlink traffic, and a third portion indicating a transmission time, determining whether the at least one target station is capable of receiving data at the transmission time, causing transmission of an acknowledgement signal indicating whether the at least one target station is capable of receiving data at the transmission time, causing the at least one target station to enter a low power mode, causing the at least one target station to wake from the lower power mode at or before the transmission time and receiving data at the transmission time.

In another embodiment, an apparatus is provided that includes at least one processor and at least one memory including computer program code with the at least one memory and the computer program code being configured to, with the processor, cause the apparatus to cause a transmission block to be provided with the transmission block comprising a first portion indicating at least one target station, a second portion indicating a presence of downlink traffic, and a third portion indicating a transmission time, receive of an acknowledgment signal from the at least one target station and cause data to be provided to the at least one target station at the transmission time.

The at least one memory and the computer program code may also configured to, with the processor, cause the apparatus to determine that the acknowledgement signal indicates that the at least one target station is unable to receive data at the transmission time and cause postponement of transmission of data to the at least one target station. In another embodiment, the transmission time is a time at which the transmission will start, and the transmission block further comprises a fourth portion indicating at least one of a transmission stop time or a transmission duration.

In another embodiment, the at least one memory and the computer program code may also configured to, with the processor, cause the apparatus to cause transmission access to be provided, wherein the transmission block further comprises a fifth portion indicating whether the provided data is transmitted unicast or multicast, and a sixth portion indicating identification of each of the at least one target station, and wherein transmission access is provided as a function of a number of target stations identified, the unicast or multicast indication and a transmission duration.

In another embodiment, the at least one memory and the computer program code may also configured to, with the processor, cause the apparatus to, when a plurality of target stations are identified and transmission is unicast, provide a number of transmission slots such that each target receives a transmission slot during the transmission duration and the transmission time indicates a transmission start time for each of the plurality of target stations respectively.

In another embodiment, the at least one memory and the computer program code may also configured to, with the processor, cause the apparatus to, when a plurality of target stations are identified and transmission is multicast, provide a single transmission slot such that each target receives the transmission at the transmission time.

In another embodiment, an apparatus is provided that includes at least one processor and at least one memory including computer program code with the at least one memory and the computer program code being configured to, with the processor, cause the apparatus to receive a transmission block comprising a first portion indicating at least one target station, a second portion indicating a presence of downlink traffic, and a third portion indicating a transmission time, determine whether the at least one target station is capable of receiving data at the transmission time, cause transmission of an acknowledgement signal indicating whether the at least one target station is capable of receiving data at the transmission time, cause the at least one target station to enter a low power mode, cause the at least one target station to wake from the lower power mode at or before the transmission time, and receive data at the transmission time.

In a further embodiment, a computer program product is provided that includes at least one non-transitory computer-readable storage medium having computer-readable program instructions stored therein with the computer-readable program instructions including program instructions configured for causing a transmission block to be provided with the transmission block comprising a first portion indicating at least one target station, a second portion indicating a presence of downlink traffic, and a third portion indicating a transmission time, receiving an acknowledgment signal from the at least one target station, and causing data to be provided to the at least one target station at the transmission time.

In another embodiment, the computer-readable program instructions may further include program instructions configured for determining that the acknowledgement signal indicates that the at least one target station is unable to receive data at the transmission time, and causing postponement of transmission of data to the at least one target station. In another embodiment, the transmission time is a time at which the transmission will start, and the transmission block further comprises a fourth portion indicating at least one of a transmission stop time or a transmission duration.

In another embodiment, the computer-readable program instructions may further include program instructions configured for causing transmission access to be provided, wherein the transmission block further comprises a fifth portion indicating whether the provided data is transmitted unicast or multicast, and a sixth portion indicating identification of each of the at least one target station, and wherein transmission access is provided as a function of a number of target stations identified, the unicast or multicast indication and a transmission duration.

In another embodiment, the computer-readable program instructions may further include program instructions configured for, when a plurality of target stations are identified and transmission is unicast, providing a number of transmission slots such that each target receives a transmission slot during the transmission duration and the transmission time indicates a transmission start time for each of the plurality of target stations respectively.

In another embodiment, the computer-readable program instructions may further include program instructions configured for, when a plurality of target stations are identified and transmission is multicast, providing a single transmission slot such that each target receives the transmission at the transmission time.

In a further embodiment, a computer program product is provided that includes at least one non-transitory computer-readable storage medium having computer-readable program instructions stored therein with the computer-readable program instructions including program instructions configured for receiving a transmission block comprising a first portion indicating at least one target station, a second portion indicating a presence of downlink traffic, and a third portion indicating a transmission time, determining whether the at least one target station is capable of receiving data at the transmission time, causing transmission of an acknowledgement signal indicating whether the at least one target station is capable of receiving data at the transmission time, causing the at least one target station to enter a low power mode, causing the at least one target station to wake from the lower power mode at or before the transmission time, and receiving data at the transmission time.

In yet another embodiment, an apparatus is provided that includes means for causing a transmission block to be provided with the transmission block comprising a first portion indicating at least one target station, a second portion indicating a presence of downlink traffic, and a third portion indicating a transmission time, receiving an acknowledgment signal from the at least one target station, and causing data to be provided to the at least one target station at the transmission time. Another embodiment may further include means for determining that the acknowledgement signal indicates that the at least one target station is unable to receive data at the transmission time and causing postponement of transmission of data to the at least one target station. In another embodiment the transmission time is a time at which the transmission will start, and the transmission block further comprises a fourth portion indicating at least one of a transmission stop time or a transmission duration. The apparatus may further include means for causing transmission access to be provided, wherein the transmission block further comprises a fifth portion indicating whether the provided data is transmitted unicast or multicast, and a sixth portion indicating identification of each of the at least one target station, and wherein transmission access is provided as a function of a number of target stations identified, the unicast or multicast indication and a transmission duration.

In another embodiment of the present invention, when a plurality of target stations are identified and transmission is unicast, the apparatus may further comprise means for providing a number of transmission slots such that each target receives a transmission slot during the transmission duration and the transmission time indicates a transmission start time for each of the plurality of target stations respectively. In another embodiment, when a plurality of target stations are identified and transmission is multicast, the apparatus may further comprise means for providing a single transmission slot such that each target receives the transmission at the transmission time.

In yet another embodiment, an apparatus is provided that includes means for receiving a transmission block comprising a first portion indicating at least one target station, a second portion indicating a presence of downlink traffic, and a third portion indicating a transmission time, determining whether the at least one target station is capable of receiving data at the transmission time, causing transmission of an acknowledgement signal indicating whether the at least one target station is capable of receiving data at the transmission time, causing the at least one target station to enter a low power mode, causing the at least one target station to wake from the lower power mode at or before the transmission time and receiving data at the transmission time.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a system in which a user equipment and/or an access point may communicate within a network in accordance with an example embodiment of the present invention;

FIG. 2 is a block diagram of an apparatus that may be embodied by or included within a user equipment, an access point or other network entity and may be specifically configured in accordance with an example embodiment of the present invention;

FIG. 3 shows an example of a synch NDP frame with timing indication;

FIG. 4 is a flow chart illustrating operations (performed e.g. by an example base station) in accordance with some example embodiments of the present invention; and

FIG. 5 is a flow chart illustrating example operations (performed e.g. by an example mobile terminal) in accordance with some example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are provided in accordance with an example embodiment of the present invention in order to support communication within a network, such as a local area network, utilizing a null data packet frame with a timing indication for triggering downlink traffic.

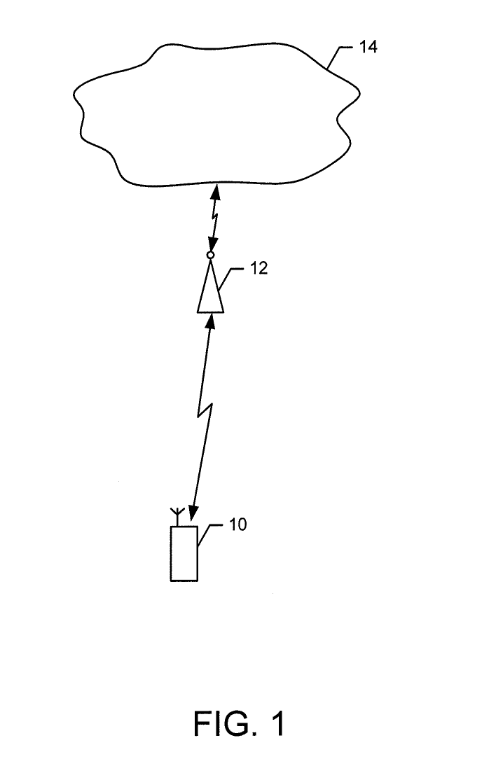

Referring now to FIG. 1, a system that supports communications between a plurality of stations 10 (one of which is illustrated by way of example) and a network 14, such as an 802.11 network, a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network, via an access point 12 is shown. Various types of stations may be employed including mobile terminals that may include, for example, mobile communication devices such as, for example, mobile telephones, PDAs, pagers, laptop computers, tablet computers or any of numerous other hand held or portable communication devices, computation devices, content generation devices, content consumption devices, or combinations thereof. Another type of stations that may be employed includes sensors. The stations may have different communication patterns depending, for example, upon the type of station. For example, some mobile terminals may exchange messages with the access point on a regular basis once an association has been established therebetween, while some sensors may communicate with the access point on a much less frequent basis. Regardless of the type of station, the station may communicate with the network via an access point, such as a base station, a Node B, an evolved Node B (eNB), a relay node or other type of access point.

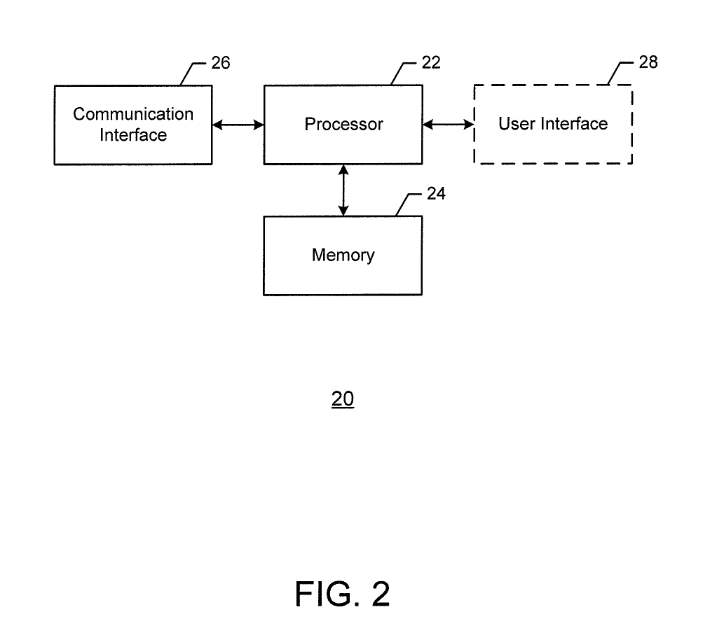

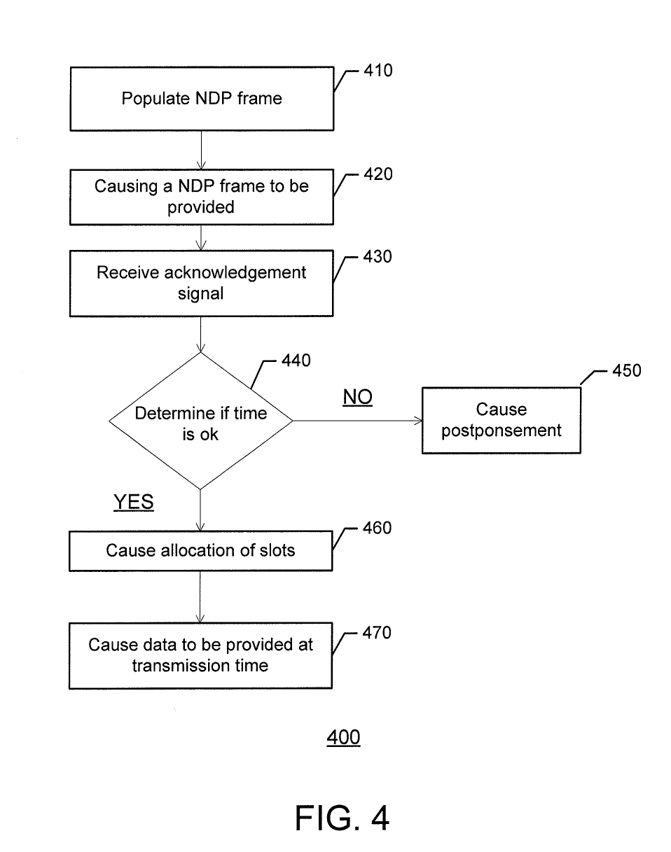

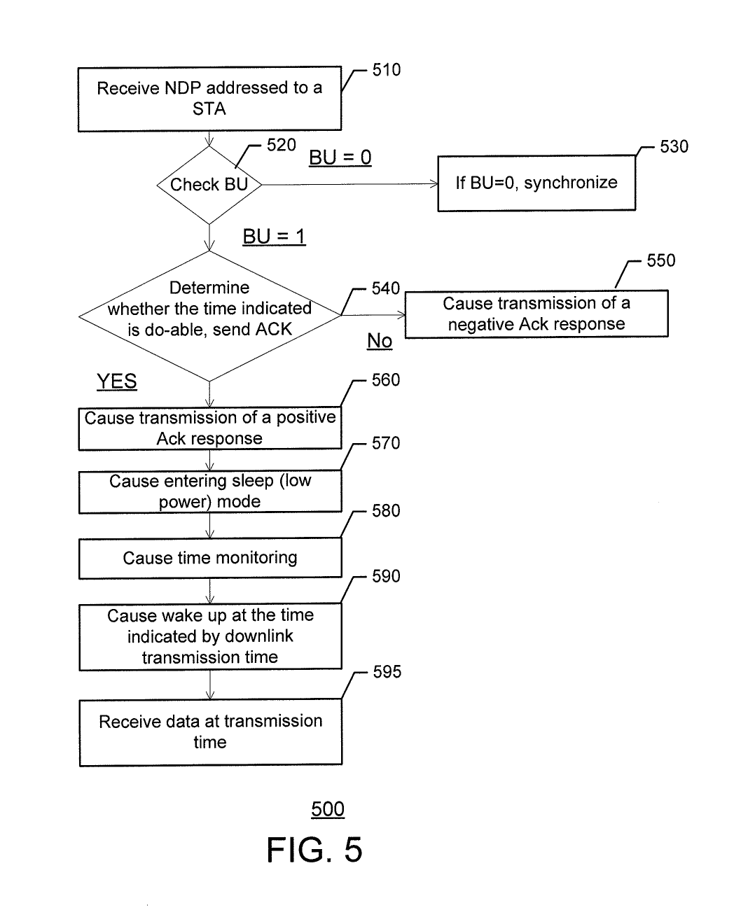

The station 10 and the access point 12 may each embody or otherwise be associated with an apparatus 20 that is generally depicted in FIG. 2 and that may be configured to perform various operations in accordance with an example embodiment of the present invention as described below, such as in conjunction with FIG. 4 from the perspective of the access point and FIG. 5 from the perspective of the station. However, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with a processing system including, for example, processing circuitry that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry may include a processor 22 and memory 24 that may be in communication with or otherwise control a communication interface 26 and, in some cases in which the apparatus is embodied by the station 10, a user interface 28. As such, the processing circuitry may be embodied as a circuit chip (e.g., an integrated circuit chip) configured (e.g., with hardware, software or a combination of hardware and software) to perform operations described herein. However, in some embodiments taken in the context of the station or the access point 12, the processing circuitry may be embodied as a portion of base station or the access point.

The user interface 28 (if implemented in embodiments of the apparatus 20 embodied by the station 10) may be in communication with the processing circuitry to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. In one embodiment, the user interface includes user interface circuitry configured to facilitate at least some functions of the station by receiving user input and providing output.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry, such as between the station 10 and the access point 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 24 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 22. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 22 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 24 or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

A method, apparatus and computer program product are provided below in order to, for example, provide a technique to trigger downlink traffic with a timing indication. In this regard, the method, apparatus and computer program product of one embodiment may utilize (1) “downlink transmission time” in the synch NDP frame indicating the beginning of downlink data transmission; (2) “downlink transmission restricted access” in the synch NDP frame starting at “downlink transmission time” during which downlink data transmission will take place to one or more STAs; (3) an indication in the NDP frame whether the downlink data transmission is unicast or broadcast; (4) ACK as a response to an NDP frame indicating whether the STA will be available to receive data at downlink transmission time or not; or (5) a new message format for the short NDP frame with timing information. The NDP synch frame additionally contains a “downlink transmission time” that gives the beginning of the downlink data transmission and a “downlink transmission restricted access” during which data is sent in the downlink to one or more STAs

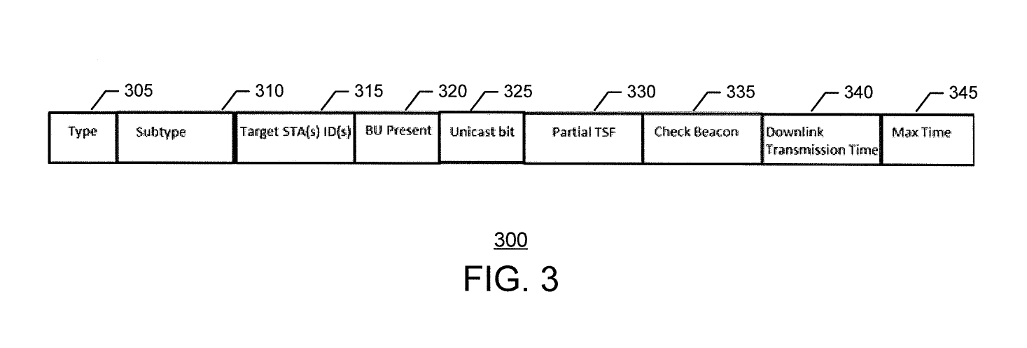

FIG. 3 shows an example of the synch NDP frame with a timing indication. In one embodiment of the present invention, the synch NDP frame with timing indication comprises a plurality of block or portions. Portions 305 and 310 show type and subtype fields. The type and subtype fields indicate the type of frame (e.g. a management type of a certain functionality). The subtype may indicate the new NDP synch frame with timing indication. Portion 315 shows target STA(s) ID(s). The target STA IDs may indicate a number of STAs being paged and/or their associated IDs (AIDs) or partial AIDs. Portion 320 shows a BU portion. The BU portion may include an indication, such as one bit, that indicates whether there is downlink traffic for the paged IDs or not. In one embodiment, the BU bit is set to 0 and may indicate that there is no downlink traffic for the STAs and/or the purpose of the frame is to synchronize the STAs. Portion 325 shows a unicast bit. The unicast bit may include an indication, such as one bit, that indicates whether the traffic from the AP is multicast to all the STAs indicated by the “Target STA(s) ID(s)” or unicast to them one by one. Portion 330 shows partial TSF. The partial TSF may include timer information for synchronization. Portion 335 shows a check beacon field. The check beacon field may indicate whether the next beacon should be checked or not by the STA. Portion 340 shows a downlink transmission time. The downlink transmission time may indicate a point in time when the downlink data transmission will start. Portion 345 shows a max time field. The max time field indicates when the downlink transmission will stop and/or how long the transmission will last.

FIGS. 4 and 5 are flowcharts illustrating the operations performed by a method, apparatus and computer program product, such as apparatus 20 of FIG. 2, in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a non-transitory memory 24 of an apparatus employing an embodiment of the present invention and executed by a processor 22 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 4 and 5, when executed, convert a computer or processing circuitry into a particular machine configured to perform an example embodiment of the present invention. Accordingly, the operations of FIGS. 4 and 5 define an algorithm for configuring a computer or processing circuitry, e.g., processor, to perform an example embodiment. In some cases, a general purpose computer may be provided with an instance of the processor which performs the algorithm of FIGS. 4 and 5 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. It should be appreciated that each of the modifications, optional additions or amplifications below may be included with the operations above either alone or in combination with any others among the features described herein.

In accordance with an example embodiment of the present invention, a synch NDP frame with a timing indication may be provided to one or more target stations. As such, FIG. 4 depicts the operations performed in order to provide a transmission signal with timing instruction for triggering downlink traffic data in one or more target stations, such as between the user equipment 10 and the access point 12 as shown in solid lines in FIG. 1 or between two or more user equipment in the case of device to device communications as shown in dashed lines in FIG. 1. The method 400 may be performed by a processing means, such as the processor 22, a processing system, processing circuitry, a processing system and/or processing circuitry described above with respect to FIG. 2.

As shown in block 410 of FIG. 4, the apparatus 20 embodied by the computing device 10 may be configured to cause population of a transmission signal or a transmission block or populating one or more portions of a transmission signal or transmission block. The apparatus embodied by the computing device may therefore include means, such as the processor 22, a processing system, processing circuitry, a processing system, processing circuitry, the communication interface 26 or the like, for causing population of a transmission signal or transmission block or causing the populating of one or more portions of a transmission signal or transmission block.

In one embodiment of the present invention, the apparatus 20 embodied by the computing device 10 may be configured to utilize the NDP frame shown in FIG. 3. As such, the apparatus 20 may be configured to cause the population of one or more of the following portions: Type and Subtype fields; Target STA(s) ID(s); BU Present; Unicast Bit; Partial Timer Synchronization function (TSF); Check Beacon; Downlink transmission time; and/or Max Time.

The Type and Subtype fields may indicate the type of frame (e.g. management) and the subtype may indicate the new NDP synch frame with timing indication. The Target STA(s) ID(s) may give the number STAs being paged and/or their associated IDs (AIDs) or partial AIDs. The BU Present bit may indicate whether there is downlink traffic for the paged IDs or not. In one embodiment, the BU bit is set to 0 when there is no downlink traffic for the STAs and/or the purpose of the frame is to synchronize the STAs. The Unicast Bit may be one or more bits that indicate whether the traffic from the AP is multicast to all the STAs indicated by the “Target STA(s) ID(s)” or unicast to them one by one. The Partial TSF may include timer information for synchronization. The Check Beacon may indicate whether the next beacon should be checked or not by the STA. The Downlink transmission time may be a point in time when the downlink data transmission will start. The Max Time may be a time when the downlink transmission will stop.

As shown in block 420 of FIG. 4, the apparatus 20 embodied by the computing device 10 may be configured to cause a transmission signal or transmission block to be provided, the transmission signal or transmission block comprising one or more portions to one or more target stations. The apparatus embodied by the computing device may therefore include means, such as the processor 22, a processing system, processing circuitry, a processing system, processing circuitry, the communication interface 26 or the like, for causing a transmission signal or transmission block to be provided, the transmission signal or transmission block comprising one or more portions to one or more target stations.

As shown in block 430 of FIG. 4, the apparatus 20 embodied by the computing device 10 may be configured to receive an acknowledgement signal from one or more target stations. The apparatus embodied by the computing device may therefore include means, such as the processor 22, a processing system, processing circuitry, a processing system, processing circuitry, the communication interface 26 or the like, for receiving an acknowledgement signal from one or more target stations.

The acknowledgement signal may comprise at least data related to whether or not the target station is able to receive data at the indicated start time. In one embodiment, if a target station is not able to receive data at the indicated time it can set the power management bit in the frame control of the acknowledgment signal to indicate that it will be in power save mode.

As shown in block 440 of FIG. 4, the apparatus 20 embodied by the computing device 10 may be configured to determine whether or not the downlink transmission time indicated in the transmission signal is able to be utilized. The apparatus embodied by the computing device may therefore include means, such as the processor 22, a processing system, processing circuitry, a processing system, processing circuitry, the communication interface 26 or the like, for causing a determination of whether or not the downlink transmission time indicated in the transmission signal is able to be utilized. In one embodiment, the processor 22, a processing system, processing circuitry, a processing system, processing circuitry, the communication interface 26 or the like, is configured for causing a determination that the acknowledgement signal indicates that the at least one target station is unable to receive data at the transmission time.

If it is determined that, based on one or more acknowledgement signals received from the one or more target stations, that the start time is not able to be utilized, the apparatus may be configured to cause the postponement of delivery of the downlink data. As such, as shown in block 450 of FIG. 4, the apparatus 20 embodied by the computing device 10 may be configured to cause the postponement or rescheduling of delivery of the downlink data. The apparatus embodied by the computing device may therefore include means, such as the processor 22, a processing system, processing circuitry, a processing system, processing circuitry, the communication interface 26 or the like, for causing postponement of the downlink data.

In another embodiment, the processor 22, a processing system, processing circuitry, a processing system, processing circuitry, the communication interface 26 or the like, is configured for causing a determination that the acknowledgement signal indicates that the at least one target station is able to receive data at the transmission time. Therefore, if it is determined that the start time indicated in the provided transmission signal is able to be utilized for delivery of the downlink data, slots are allocated and the data is delivered as scheduled. As shown in block 460 of FIG. 4, the apparatus 20 embodied by the computing device 10 may be configured to cause allocation of slots for delivery of the downlink data. The apparatus embodied by the computing device may therefore include means, such as the processor 22, a processing system, processing circuitry, a processing system, processing circuitry, the communication interface 26 or the like, for causing allocation of slots for delivery of the downlink data.

In one embodiment of the present invention, the synch NDP frame with timing indication may be sent in a Restricted Access Window (RAW) slot. A RAW may be a set of slots that can be assigned to different stations either for individual access during a slot or for group access. In one embodiment, a Restricted Access Window (RAW) is divided in time slots. A STA may wake up at a target beacon transition time (TBTT) and may listen to a Beacon frame indicating the slot duration for each Restricted Access Window (RAW). A slot duration for each RAW may be different. A STA may determine its channel access slot assigned by AP and may sleep before its channel access slot. A STA may start to access the channel at the slot boundary of its channel access slot based on EDCA. In one embodiment, an AP may indicate whether the following TXOP rule is applied in each RAW: (1) A TXOP or transmission within a TXOP may not extend across a slot boundary; and (2) If the above TXOP rule is applied, the STA may not wait for ProbeDelay when waking up at the slot boundary. Additionally or alternatively, different slots in the RAW can be allocated to different STAs or groups of STAs. In one embodiment, a group of STAs in a common slot may share common traffic type. Accordingly, traffic type may dictate a maximum latency requirement and may also dictate a priority as compared to other downlink traffic priorities. In one embodiment, STAs in a common slot may have the same type (e.g., sensors, mobile STAs).

The downlink transmission time may be in terms of (1) time Units (TUs) or scaled TUs (e.g., data transmission will begin after the time indicated by the TU increased or decreased by a given factor) or (2) a beacon interval (e.g., data transmission will begin after a certain beacon). In one embodiment of the present invention, the downlink transmission time may depend on a traffic class and/or a delay requirement of the STA's traffic (i.e. smaller values for more time critical traffic with strict delay constraints).

The “downlink transmission restricted access” during which downlink data transmission will take place depends on the number of paged STAs. In one embodiment, the “downlink transmission restricted access” during which downlink data transmission will take place depends on the number of paged STAs similar to random access window (RAW) or Periodic-RAW (PRAW) for the case of downlink traffic. Additionally or alternatively, the downlink transmission restricted access may be indicated through a max time and the number of STAs that receive downlink traffic, such that the downlink transmission time and the maximum (max) time give the downlink transmission duration, namely, the downlink transmission duration is equal to the max time less the downlink transmission time. In one embodiment, if a single STA is paged (and BU=1), the whole duration may be given to a single STA. An AP may control the slot length by controlling the maximum time based on the amount of data and number of STAs. In this case, a single STA will receive downlink traffic. In another embodiment, if a group of STAs is paged (and BU=1) and if the unicast indicator bit is set: the number of slots will be such that each STA in the group receives a slot. For example, the number of slots may be a function of downlink transmission duration and the number of STAs (e.g., downlink transmission duration divided by a number of STAs). In this case, each STA in the group of STAs may have to match its AID to a slot in the downlink transmission restricted access (e.g., the smallest AID takes the first slot, the second smallest the second and so on so forth). In another embodiment, if a group of STAs is paged (and BU=1) and if the unicast indicator bit is not set (indicating broadcast transmission), downlink transmission restricted access occurs in a single slot and all STAs in the group wake up to receive the downlink at the indicated time.

In accordance with an example embodiment of the present invention, a synch NDP frame with a timing indication may be received by one or more target stations. As such, FIG. 5 depicts the operations performed in order to receive a transmission signal with timing instruction for triggering downlink traffic data in one or more target stations, such as between the user equipment 10 and the access point 12 as shown in solid lines in FIG. 1 or between two or more user equipment in the case of device to device communications as shown in dashed lines in FIG. 1. The method 500 may be performed by a processing means, such as the processor 22, a processing system, processing circuitry, a processing system, processing circuitry described above with respect to FIG. 2.

As shown in block 510 of FIG. 5, the apparatus 20 embodied by the computing device 10 may be configured to receive a transmission signal or a transmission block or receive one or more portions of a transmission signal or a transmission block. The apparatus embodied by the computing device may therefore include means, such as the processor 22, a processing system, processing circuitry, a processing system, processing circuitry, the communication interface 26 or the like, for receiving a transmission signal or a transmission block or reception of one or more portions of a transmission signal or a transmission block.

In one embodiment of the present invention, the apparatus 20 embodied by the computing device 10 may be configured to receive the synch NDP frame shown in FIG. 3. As such, the apparatus 20 may be configured to receive a transmission signal comprising one or more of the following portions: Type and Subtype fields; Target STA(s) ID(s); BU Present; Unicast Bit; Partial TSF; Check Beacon; Downlink transmission time; and/or Max Time.

In one embodiment of the present invention, the Type and Subtype fields may indicate the type of frame (e.g. management) and the subtype may indicate the new NDP synch frame with timing indication. The Target STA(s) ID(s) may give the number of STAs being paged and/or their associated IDs (AIDs) or partial AIDs. The BU Present bit may indicate whether there is downlink traffic for the paged IDs or not. In one embodiment, the BU bit is set to 0 when there is no downlink traffic for the STAs and/or when the purpose of the frame is to synchronize the STAs. The Unicast Bit may be one or more bits that indicate whether the traffic from the AP is multicast to all the STAs indicated by the “Target STA(s) ID(s)” or unicast to them one by one. The Partial TSF may include timer information for synchronization. The Check Beacon may indicate whether the next beacon should be checked or not by the STA. The Downlink transmission time may be a point in time when the downlink data transmission will start. The Max Time may be a time when the downlink transmission will stop.

As shown in block 520 of FIG. 5, the apparatus 20 embodied by the computing device 10 may be configured to check the BU signal. The apparatus embodied by the computing device may therefore include means, such as the processor 22, a processing system, processing circuitry, a processing system, processing circuitry, the communication interface 26 or the like, for causing the checking of the BU signal. In an embodiment where the BU bit is set to 0 or indicates that there is no downlink data to receive, the synch NDP signal may be determined to be a synch signal. As such, as shown in block 530 of FIG. 5, the apparatus 20 embodied by the computing device 10 may be configured to synchronize with for example, the AP and/or other STAs. The apparatus embodied by the computing device may therefore include means, such as the processor 22, a processing system, processing circuitry, a processing system, processing circuitry, the communication interface 26 or the like, for causing synchronization with, for example, the AP and/or other STAs.

In an embodiment where the BU bit is set to 1 or indicates that there is downlink data to receive, the apparatus 20 embodied by the computing device 10 may then therefore be configured to determine whether or not the STA is able to receive data at the indicated time (See block 540 of FIG. 5). The apparatus embodied by the computing device therefore includes means, such as the processor 22, a processing system, processing circuitry, a processing system, processing circuitry, the communication interface 26 or the like, for causing determination of whether or not the STA is able to receive data at the indicated time.

In one embodiment, if the BU indication is set and the STA is able to receive data at the indicated time, as shown in block 560 of FIG. 5, the apparatus 20 embodied by the computing device 10 may be configured to send a positive ACK response. The apparatus embodied by the computing device may therefore include means, such as the processor 22, a processing system, processing circuitry, the communication interface 26 or the like, for causing the transmission of a positive ACK response.

In one embodiment, a STA may respond to an NDP frame with a timing indication with an ACK to acknowledge that it is able to receive data at the indicated time. Data may be included in the ACK frame sent by the STA if data is present. If multiple STAs receive the NDP frame with a timing indication, the STAs may contend either according to random access or through scheduled access (e.g., RAW to send their ACKs).

As shown in block 550 of FIG. 5, the apparatus 20 embodied by the computing device 10 may be configured to send a negative ACK response. The apparatus embodied by the computing device may therefore include means, such as the processor 22, a processing system, processing circuitry, the communication interface 26 or the like, for causing the transmission of a negative ACK response. In one embodiment, if a STA is not able to receive data at the indicated time, the STA may set the power management bit in the frame control of the ACK to indicate that it will be in power save mode. The AP may then postpone delivery of the downlink data.

As shown in block 570 of FIG. 5, the apparatus 20 embodied by the computing device 10 may be configured to cause the STA to enter a sleep mode or other low power mode. The apparatus embodied by the computing device may therefore include means, such as the processor 22, a processing system, processing circuitry, the communication interface 26 or the like, for causing the STA to enter a sleep mode or other low power mode.

As shown in block 580 of FIG. 5, the apparatus 20 embodied by the computing device 10 may be configured to cause the STA monitor the time. The apparatus embodied by the computing device may therefore include means, such as the processor 22, a processing system, processing circuitry, the communication interface 26 or the like, for causing the STA to monitor the time.

As shown in block 590 of FIG. 5, the apparatus 20 embodied by the computing device 10 may be configured to cause the STA to wake from a sleep mode or other low power mode. The apparatus embodied by the computing device may therefore include means, such as the processor 22, a processing system, processing circuitry, the communication interface 26 or the like, for causing the STA to wake from a sleep mode or other low power mode.

As shown in block 595 of FIG. 5, the apparatus 20 embodied by the computing device 10 may be configured to cause the STA to receive downlink transmission data at the indicated transmission time. The apparatus embodied by the computing device may therefore include means, such as the processor 22, a processing system, processing circuitry, the communication interface 26 or the like, for causing the STA to receive the downlink data at the indicated transmission time.

In one embodiment, upon reception of an NDP addressed to a STA with BU set to 1, the STA receiving the NDP, enters a sleep mode or other low power mode and wakes up at the downlink transmission time to receive the downlink traffic. Additionally or alternatively, the STA may not need to listen to beacons and/or short beacons that follow the synch NDP frame but precede the time indicated in the synch NDP frame.

The method, apparatus and computer program product of an example embodiment may also provide meaningful flexibility. In this regard, the allocation of transmission slots, control signals and data is flexible in regards to time and frequency since control signals and data signals are allowed to be transmitted at different subcarrier bandwidths. Additionally, control signals and data signals may have different symbol durations, thereby allowing more flexible control arrangement. Further, the actual allocation of transmission slots, control signals and data signals may be quite flexible in that the resource sharing pattern can either by dynamic or stable. Further, the method, apparatus and computer program product of an example embodiment may flexibly share the resources for multiple users and/or services.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
causing a transmission block to be provided with the transmission block comprising a first portion indicating at least one target station, a second portion indicating a presence of downlink traffic, and a third portion indicating a transmission time;
receiving an acknowledgment signal from the at least one target station; and
causing data to be provided to the at least one target station at the transmission time.

2. A method according to claim 1 further comprising:
determining that the acknowledgement signal indicates that the at least one target station is unable to receive data at the transmission time; and
causing postponement of transmission of data to the at least one target station.

3. A method according to claim 1,
wherein the transmission time is a time at which the transmission will start, and
wherein the transmission block further comprises a fourth portion indicating at least one of a transmission stop time or a transmission duration.

4. A method according to claim 3 further comprising: causing transmission access to be provided,
wherein the transmission block further comprises a fifth portion indicating whether the provided data is transmitted unicast or multicast, and a sixth portion indicating identification of each of the at least one target station,
wherein transmission access is provided as a function of a number of target stations identified, the unicast or multicast indication and a transmission duration.

5. A method according claim 4, wherein when a plurality of target stations are identified and transmission is unicast, the method further comprises providing a number of transmission slots such that each target receives a transmission slot during the transmission duration and the transmission time indicates a transmission start time for each of the plurality of target stations respectively.

6. A method according claim 4, wherein when a plurality of target stations are identified and transmission is multicast, the method further comprises providing a single transmission slot such that each target receives the transmission at the transmission time.

7. A method comprising:
receiving a transmission block comprising a first portion indicating at least one target station, a second portion indicating a presence of downlink traffic, and a third portion indicating a transmission time;
determining whether the at least one target station is capable of receiving data at the transmission time;
causing transmission of an acknowledgement signal indicating whether the at least one target station is capable of receiving data at the transmission time;
causing the at least one target station to enter a low power mode;
causing the at least one target station to wake from the lower power mode at or before the transmission time; and
receiving data at the transmission time.

8. An apparatus comprising at least one processor and at least one memory including computer program code, the at least one memory and the computer program code configured to, with the processor, cause the apparatus to at least:
cause a transmission block to be provided with the transmission block comprising a first portion indicating at least one target station, a second portion indicating a presence of downlink traffic, and a third portion indicating a transmission time;
receive of an acknowledgment signal from the at least one target station; and
cause data to be provided to the at least one target station at the transmission time.

9. An apparatus according to claim 8 wherein the at least one memory and the computer program code are further configured to, with the processor, cause the apparatus to:
determine that the acknowledgement signal indicates that the at least one target station is unable to receive data at the transmission time; and
cause postponement of transmission of data to the at least one target station.

10. An apparatus according to claim 8 wherein the transmission time is a time at which the transmission will start, and wherein the transmission block further comprises a fourth portion indicating at least one of a transmission stop time or a transmission duration.

11. An apparatus according to claim 9 wherein the at least one memory and the computer program code are configured to, with the processor, cause the apparatus to cause transmission access to be provided,
wherein the transmission block further comprises a fifth portion indicating whether the provided data is transmitted unicast or multicast, and a sixth portion indicating identification of each of the at least one target station,
wherein transmission access is provided as a function of a number of target stations identified, the unicast or multicast indication and a transmission duration.

12. An apparatus according to claim 8, wherein when a plurality of target stations are identified and transmission is unicast, the at least one memory and the computer program code are further configured to, with the processor, cause the apparatus to provide a number of transmission slots such that each target receives a transmission slot during the transmission duration and the transmission time indicates a transmission start time for each of the plurality of target stations respectively.

13. An apparatus according to claim 8 wherein when a plurality of target stations are identified and transmission is multicast, the at least one memory and the computer program code are configured to, with the processor, cause the apparatus to provide a single transmission slot such that each target receives the transmission at the transmission time.

14. An apparatus comprising at least one processor and at least one memory including computer program code, the at least one memory and the computer program code configured to, with the processor, cause the apparatus to at least:
receive a transmission block comprising a first portion indicating at least one target station, a second portion indicating a presence of downlink traffic, and a third portion indicating a transmission time;
determine whether the at least one target station is capable of receiving data at the transmission time;
cause transmission of an acknowledgement signal indicating whether the at least one target station is capable of receiving data at the transmission time;
cause the at least one target station to enter a low power mode;
cause the at least one target station to wake from the lower power mode at or before the transmission time; and
receive data at the transmission time.

15. A computer program product comprising at least one non-transitory computer-readable storage medium having computer-readable program instructions stored therein with the computer-readable program instructions comprising program instructions configured for:
causing a transmission block to be provided with the transmission block comprising a first portion indicating at least one target station, a second portion indicating a presence of downlink traffic, and a third portion indicating a transmission time;
receiving an acknowledgment signal from the at least one target station; and
causing data to be provided to the at least one target station at the transmission time.

16. A computer program product according to claim 15 wherein the computer-readable program instructions further comprise program instructions configured for:
determining that the acknowledgement signal indicates that the at least one target station is unable to receive data at the transmission time; and
causing postponement of transmission of data to the at least one target station.

17. A computer program product according to claim 15 wherein the transmission time is a time at which the transmission will start, and
wherein the transmission block further comprises a fourth portion indicating at least one of a transmission stop time or a transmission duration.

18. A computer program product according to claim 15 wherein the computer-readable program instructions further comprise program instructions configured for: causing transmission access to be provided,
wherein the transmission block further comprises a fifth portion indicating whether the provided data is transmitted unicast or multicast, and a sixth portion indicating identification of each of the at least one target station,
wherein transmission access is provided as a function of a number of target stations identified, the unicast or multicast indication and a transmission duration.

19. A computer program product according to claim 15 wherein when a plurality of target stations are identified and transmission is unicast, the computer-readable program instructions further comprise program instructions configured for providing a number of transmission slots such that each target receives a transmission slot during the transmission duration and the transmission time indicates a transmission start time for each of the plurality of target stations respectively.

20. A computer program product according to claim 15 wherein when a plurality of target stations are identified and transmission is multicast, the computer-readable program instructions further comprise program instructions configured for providing a single transmission slot such that each target receives the transmission at the transmission time.

21. A computer program product comprising at least one non-transitory computer-readable storage medium having computer-readable program instructions stored therein with the computer-readable program instructions comprising program instructions configured for:
receiving a transmission block comprising a first portion indicating at least one target station, a second portion indicating a presence of downlink traffic, and a third portion indicating a transmission time;
determining whether the at least one target station is capable of receiving data at the transmission time;
causing transmission of an acknowledgement signal indicating whether the at least one target station is capable of receiving data at the transmission time;
causing the at least one target station to enter a low power mode;
causing the at least one target station to wake from the lower power mode at or before the transmission time; and
receiving data at the transmission time.
